(19) United States
(12) Patent Application Publication
(10) Pub. No.: US 2003/0059026 A1
(43) Pub. Date: Mar. 27, 2003

(54) Method and apparatus for telecommunications link capacity determination

(76) Inventors: David L. Brugman, San Clemente, CA (US); Donald R. Smiley, Naperville, IL (US); David L. Spaay, Oswego, IL (US); Adrian L. Thomas, Naperville, IL (US); Nelson Tom, Plainsboro, NJ (US)

Correspondence Address: Richard J. Minnich, Esq., Fay, Sharpe, Fagan, Minnich & McKee, LLP, 1100 Superior Avenue, Seventh Floor, Cleveland, OH, 44114-2518, US

(21) Appl. No.: 09/960,252

(22) Filed: Sep. 21, 2001

(51) Int. Cl. H04M 7/00

(52) U.S. Cl. 379/229

(57) ABSTRACT

A remote switch monitoring system and method monitors traffic between the publicly switched telephone network (PSTN) and a remote switching module (RSM). That is, the remote switch monitoring system monitors traffic through the umbilical link between a remote switching module and a host and segregates traffic between the PSTN and the RSM from other traffic on the umbilical link. This segregated PSTN/RSM umbilical link traffic information may be used, for example, by a service provider to determine the capacity of an umbilical link, the capacity of a trunk, or for host switch connection requirements when upgrading a remote switch module. In an illustrative embodiment, the remote switch monitoring system employs a computer to monitor called number, calling number, originating point code and destination point code information for calls between lines terminated at the remote switching module and lines terminated elsewhere. Out of band signaling, such as SS7 data, may be employed to obtain such information.

### FIELD OF THE INVENTION

The invention relates to telecommunications systems and, more particularly, to a system and method for the determination of link capacity requirements for remote switching modules.

### BACKGROUND OF THE INVENTION

Remote switching modules are widely used within telecommunications systems to provide circuit-switching capacity to end-users, typically to end-users in remote geographical locations. The remote switching module provides direct line-to-line interconnection to all attached users. An “umbilical” link to a host switch provides access, through the host switch, to the public switched telephone network. The remote switching module operates analogous to a private branch exchange with additional functionality, such as 911 and other such services. Automatic message accounting is not, however, a feature included in a remote switching modules suite of features.

In many circumstances, such as an upgrade to a remote switching module or a switchover from one host to another, for example, information regarding the volume of telecommunications traffic through the umbilical that is associated with calls between the publicly switched telephone network and the remote switching module would be highly useful.

In order to properly engineer an umbilical link's capacity, or to engineer alternative link capacities, the expected traffic levels should be determined. That is, an umbilical with insufficient capacity would restrict traffic flow, thereby disrupting service to end-users connected through the remote switch to a host switch and, through the host switch, to the publicly switched telephone system. Excessive disruptions of this sort would, naturally, lead to customer dissatisfaction and consequent loss of revenue on the part of the service provider who operates the remote switching module. On the other hand, should too much capacity be built into the umbilical link, the service provider, by paying for the excess capacity, would not enjoy the profits one would otherwise expect (and could experience losses).

Newer remote switching modules may provide for a variety of links, including an umbilical link to a host or trunks to one or more other switches, for example. In order to properly size any of these links, correct traffic information related to calls between an existing remote switching module and the publicly switched telephone network (through the host switch) is critical.

A remote switch monitoring system and method that provides traffic-level information for a remote switch module would therefore be highly desirable.

### SUMMARY

A remote switch monitoring system and method in accordance with the principles of the present invention monitors traffic between the publicly switched telephone network (PSTN) and a remote switching module (RSM). That is, the remote switch monitoring system monitors traffic through the umbilical link between a remote switching module and a host and segregates traffic between the PSTN and the RSM from other traffic on the umbilical link. This segregated PSTN/RSM umbilical link traffic information may be used, for example, by a service provider to determine the capacity of an umbilical link, the capacity of a trunk, or for host switch connection requirements when upgrading a remote switch module. In an illustrative embodiment, the remote switch monitoring system employs a computer to monitor called number, calling number, originating point code and destination point code information for calls between lines terminated at the remote switching module and lines terminated elsewhere. Out of band signaling, such as SS7 data, may be employed to obtain such information. In an illustrative embodiment, the duration of each such call is also determined by the monitoring system. The monitoring system compiles such information and provides usage reports over a time period determined by an end-user, such as a service provider. The end-user may specify a reporting period which allows for the accumulation of usage data during a peak period, for example, so that the service provider may engineer umbilical links, trunks, and host connection requirements to accommodate such peak requirements.

The remote switching module monitoring system's reports may include incoming usage to the remote switch from all other switches in the network, outgoing usage from the remote system to all other switches in the network, usage of the umbilical link in both directions, and link usage within the remote switch, or cluster of remote switches. The reports may include total usage related to each outgoing point code, with an optional called number (NPA-NXX) summary, total usage related from each destination point code, with an optional called number CNPA-NXX) summary, each report reflecting only calls originating in or terminating in the remote switch module. The reports may also include information related to the number of “normal clearing” and “busy clearing” calls, with associated called number, point code, and circuit identification code information.

### BRIEF DESCRIPTION OF THE DRAWINGS

The above and further features, aspects, and advantages of the invention will be apparent to those skilled in the art from the following detailed description, taken together with the accompanying drawings in which:

FIG. 1 is a conceptual block diagram of a remote switch module monitoring system in accordance with the principles of the present invention;

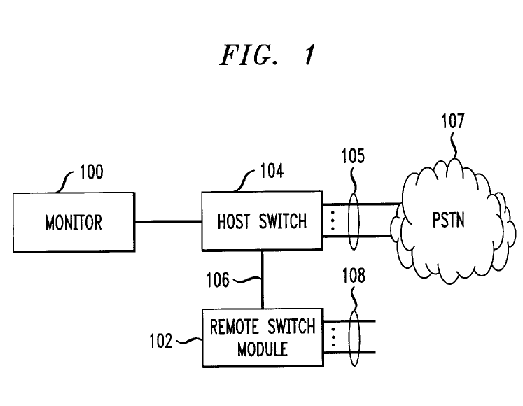

FIG. 2 is a conceptual block diagram of a computer system which may be employed in a document control system in accordance with the principles of the present invention;

FIG. 3 is a flowchart depicting a process in accordance with the principles of the present invention of monitoring call traffic between a remote switching system and a host switch; and

FIG. 4 is a flowchart depicting a process in accordance with the principles of the present invention whereby a remote monitoring system derives information related to a specific call of interest.

### DETAILED DESCRIPTION

A remote switch monitoring system 100 in accordance with the principles of the present invention provides information for use by an end-user such as a telecommunications service provider. The remote switch monitoring system 100 monitors traffic between a remote switching module 102 and a host switch 104 through a monitor connection 105 and provides traffic information related to the umbilical link 106. In particular the remote switch monitoring system 100, segregates calls between the publicly switched telephone network (PSTN) and the remote switching module (RSM) to provide reports to an end-user regarding the inter-PSTN/RSM call traffic. The host switch 104 is connected through one or more trunks 105 to the publicly switched telephone network. The remote switching module 102 may, in fact be a cluster of remote switches each of which includes features, such as 911 service, but all of which rely upon a host switch 104 for automatic message accounting.

The link traffic information may be used, for example, by a service provider to determine the capacity of an umbilical link, the capacity of a trunk, or for host switch connection requirements when upgrading a remote switch module. In an illustrative embodiment, the remote switch monitoring system 100 employs a computer to monitor called number, calling number, originating point code and destination point code information for calls between lines 108 terminated at the remote switching module and lines terminated elsewhere. Out of band signaling, such as SS7 data, may be employed to obtain such information. In an illustrative embodiment, the duration of each such call is also determined by the monitoring system. The monitoring system 100 compiles such information and provides usage reports over a time period determined by an end-user, such as a service provider. The end-user may specify a reporting period that allows for the accumulation of usage data during a peak period, for example, so that the service provider may engineer umbilical links, trunks, and host connection requirements to accommodate such peak requirements.

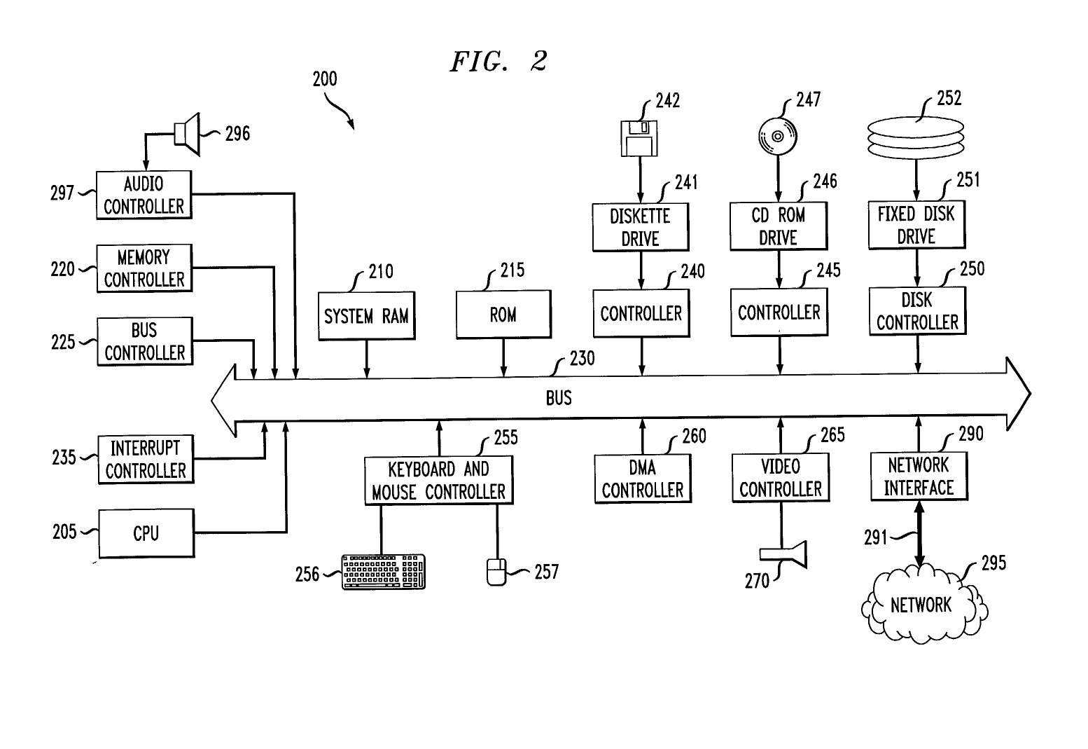

FIG. 2 illustrates the system architecture for a computer system, or controller, 200 on which the invention may be implemented. One or more such computer systems may be employed for the remote switch monitoring system 100. The exemplary computer system of FIG. 2 is for descriptive purposes only. Although the description may refer to terms commonly used in describing particular computer systems, the description and concepts equally apply to other systems, including systems having architectures dissimilar to FIG. 2.

Computer system 200 includes a central processing unit CPU) 205, which may be implemented with a conventional microprocessor, a random access memory (RAM) 210 for temporary storage of information, and a read only memory (ROM) 215 for permanent storage of information. A memory controller 220 is provided for controlling RAM 210.

A bus 230 interconnects the components of computer system 200. A bus controller 225 is provided for controlling bus 230. An interrupt controller 235 is used for receiving and processing various interrupt signals from the system components.

Mass storage may be provided by diskette 242, CD ROM 247, or hard drive 252. Data and software may be exchanged with computer system 200 via removable media such as diskette 242 and CD ROM 247. Diskette 242 is insertable into diskette drive 241 which is, in turn, connected to bus 230 by a controller 240. Similarly, CD ROM 247 is insertable into CD ROM drive 246 which is, in turn, connected to bus 230 by controller 245. Hard disc 252 is part of a fixed disc drive 251 which is connected to bus 230 by controller 250. User input to computer system 200 may be provided by a number of devices. For example, a keyboard 256 and mouse 257 are connected to bus 230 by controller 255. An audio transducer 296, which may act as both a microphone and a speaker, is connected to bus 230 by audio controller 297, as illustrated. It will be obvious to those reasonably skilled in the art that other input devices, such as a pen and/or tabloid may be connected to bus 230 and an appropriate controller and software, as required. DMA controller 260 is provided for performing direct memory access to RAM 210. A visual display is generated by video controller 265 which controls video display 270. Computer system 200 also includes a communications adaptor 290 which allows the system to be interconnected to a local area network (LAN) or a wide area network (WAN), schematically illustrated by bus 291 and network 295. An input interface 299 operates in conjunction with an input device 293 to permit a user to send information, whether command and control, data, or other types of information, to the system 200. The input device and interface may be any of a number of common interface devices, such as a joystick, a touch-pad, a touch-screen, a speech-recognition device, or other known input device.

Operation of computer system 200 is generally controlled and coordinated by operating system software. The operating system controls allocation of system resources and performs tasks such as processing scheduling, memory management, networking, and I/O services, among things. In particular, an operating system resident in system memory and running on CPU 205 coordinates the operation of the other elements of computer system 200. The present invention may be implemented with any number of operating systems, including commercially available operating systems. One or more applications, such may also run on the CPU 205. If the operating system is a true multitasking operating system, multiple applications may execute simultaneously.

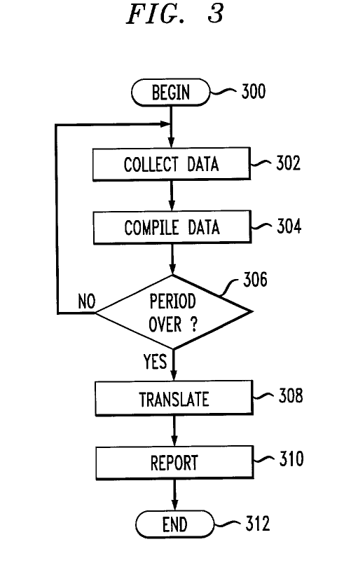

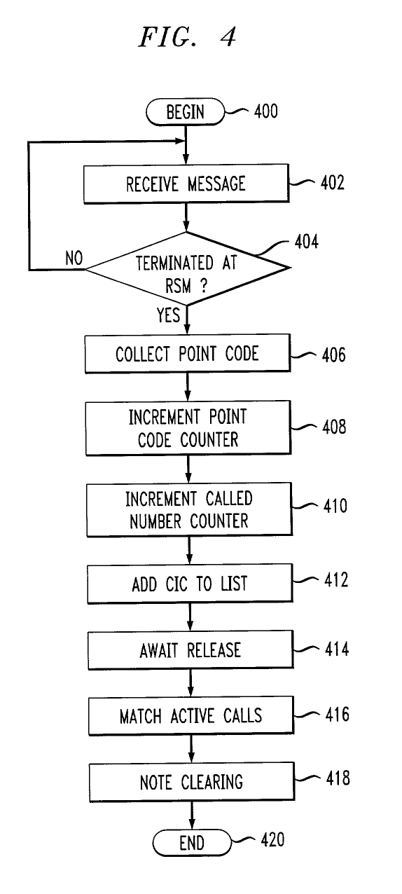

The flow chart of FIG. 3 outlines a call monitoring process in accordance with the principles of the present invention. The process begins in step 300 and proceeds to step 302 where the monitoring system 100 gathers call information related to lines terminated at a remote switch module 102 of interest. As will be explained in greater detail in the description related to the flow chart of FIG. 4, in this illustrative embodiment the monitoring system 100 “traps on” out of band SS7 signaling related to a range of numbers that correspond to the lines 108 terminated at the remote switch module 102. From step 302 the process proceeds to step 304 where the call-related data is compiled. From step 304 the process proceeds to step 306 where the monitoring system determines whether the user-specified period of monitoring has been completed. In the illustrative embodiment, the period is at least seven twenty-four hour periods. A user, such as a telecommunications service provider, may determine to monitor call traffic during a typically peak period in order to obtain a worst-case “snapshot” of the inter PSTN/RSM traffic through the umbilical link 106.

If the monitoring period has not run, the process returns to step 302 and from there as previously described. If, on the other hand, the period has run, the process proceeds from step 306 to step 308 where the remote monitoring system 100 translates the called- and calling-number related data into switch-related data. In an illustrative embodiment the remote monitoring system 100 employs a local routing guide to map numbers to offices and city, thereby providing the user with the city, office, and duration of PSTN/RSM calls originating at or having the destination of lines terminated at the remote switching module 102. From step 308 the process proceeds to step 310 where the remote monitoring system reports the call data, and may employ various graphical, tabular, and interactive information display techniques. In this illustrative embodiment, the reports include incoming usage to the remote switch from all other switches in the network, outgoing usage from the remote system to all other switches in the network, usage of the umbilical link 106 in both directions, and link usage within the remote switch, or cluster of remote switches. The reports may include total usage related to each outgoing point code, with an optional called number (NPA-NXX) summary, total usage related from each destination point code, with an optional called number (NPA-NXX) summary, each report reflecting only calls originating in or terminating in the remote switch module 102. The reports may also include information related to the number of normal clearing and busy clearing calls, with associated called number, point code, and circuit identification code information. From step 310 the process proceeds to end in step 312.

The flow chart of FIG. 4 provides a more detailed view of step 302 in which call data is gathered by illustrating the process of monitoring a single call. The process begins in step 400 and proceeds to step 402 where an SS7 initial address message is received at the remote monitoring system 100. For incoming calls to the host 104 the remote monitoring system 100 searches for the remote switch module's number range within the called number field of the initial address message. Similarly, for outgoing calls from the host 104, the remote monitoring system 100 searches for the remote switch module's number range within the called number field of the initial address message.

In step 404, if the initial address message indicates that the call does not involve a line terminated at the remote switch module 102, the process returns to step 402 and proceeds as previously described. If a match is found in step 404, the process proceeds to step 406 where the monitoring system 100 collects the originating point code (each office has a point code associated with it), circuit identification code (each trunk has a circuit identification code associated with it), and calling number data (including area code and three digit prefix). From step 406 the process proceeds to step 408 where the monitor increments a counter related to the point code, thereby keeping track of the number of calls to the related point code. From step 408 the process proceeds to step 410 where a counter related to the called number is incremented. From step 410 the process proceeds to step 412 where the circuit identification code is added to a list of active circuit identification codes. The process then proceeds to step 414 where the monitor awaits an SS7 release message for the call of interest. During the waiting period a counter is incremented at regular intervals, each second, for example, to keep track of the number of active calls during that time slot, thereby providing a circuit identification code-second, tabulation for the interval. Data for each interval, and cumulative data (total usage-seconds) is maintained by the monitoring system. This waiting period of step 414 may be may use interrupt-driven, or polling techniques, and in this illustrative embodiment.

When an SS7 call Release message is issued, the monitoring system 100 attempts to match the point code and circuit identification code to active calls in step 416. If a match is found, the circuit identification code related to the call is removed from the active list. In step 418 the monitoring system notes whether the release was through normal clearing or busy clearing. From step 418, the process proceeds to end in step 420.

A software implementation of the above described embodiment(s) may comprise a series of computer instructions either fixed on a tangible medium, such as a computer readable media, e.g. diskette, CD-ROM, ROM, or fixed disc of FIG. 2, or transmittable to a computer system, via a modem or other interface device, such as communications adapter connected to the network over a medium. Medium can be either a tangible medium, including but not limited to, optical or analog communications lines, or may be implemented with wireless techniques, including but not limited to microwave, infrared or other transmission techniques. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, preloaded with a computer system, e.g., on system ROM or fixed disc, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Further, the methods of the invention may be achieved in either all software implementations, using the appropriate object or processor instructions, or in hybrid implementations that utilize a combination of hardware logic, software logic and/or firmware to achieve the same results. Processes illustrated through the use of flow charts may not be strictly linear processes and alternative flows may be implemented within the scope of the invention. The specific configuration of logic and/or instructions utilized to achieve a particular function, as well as other modifications to the inventive concept are intended to be covered by the appended claims.

The foregoing description of specific embodiments of the invention has been presented for the purposes of illustration and description. It is not intended to be exhaustive or to limit the invention to the precise forms disclosed, and many modifications and variations are possible in light of the above teachings. The embodiments were chosen and described to best explain the principles of the invention and its practical application, and to thereby enable others skilled in the art to best utilize the invention.

The foregoing description merely illustrates the principles of the invention. It will thus be appreciated that those skilled in the art will be able to devise various arrangements, which, although not explicitly described or shown herein, embody the principles of the invention, and are included within its spirit and scope. Furthermore, all examples and conditional language recited are principally intended expressly to be only for instructive purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof any element expressed as a means for performing a specified function is intended to encompass any way of performing that function including, for example, a) a combination of circuit elements which performs that function orb) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Many other modifications and applications of the principles of the invention will be apparent to those skilled in the art and are contemplated by the teachings herein. Accordingly, the scope of the invention is limited only by the claims appended hereto.

What is claimed is:

1. An apparatus comprising:
a monitor connection for receiving out of band signaling from a host telecommunications switch, and
a controller configured to monitor traffic between the publicly switched telephone network (PSTN) and a remote switching module (RSM).

2. The apparatus of claim 1 wherein the controller is further configured to monitor traffic through an umbilical link between an RSM and the host telecommunications switch and to segregate traffic between the PSTN and the RSM from other traffic on the umbilical link.

3. The apparatus of claim 1 wherein the controller is configured to monitor called number information within out of band signaling from the host telecommunications switch.

4. The apparatus of claim 1 wherein the controller is configured to monitor calling number information within out of band signaling from the host telecommunications switch.

5. The apparatus of claim 1 wherein the controller is configured to monitor originating point codes within the out of band signaling from the host telecommunications switch.

6. The apparatus of claim 1 wherein the controller is configured to monitor destination point codes within the out of band signaling from the host telecommunications switch.

7. The apparatus of claim 1 wherein the controller is configured to report incoming usage to the remote switching module from all other switches within the PSTN.

8. The apparatus of claim 1 wherein the controller is configured to report outgoing usage from the remote switching module to all other switches within the PSTN.

9. The apparatus of claim 1 wherein the controller is configured to report usage of the umbilical link between the host telecommunications switch and the remote switching module in both directions.

10. The apparatus of claim 1 wherein the controller is configured to report usage of the umbilical link for calls between lines terminated by the remote switching module.

11. The apparatus of claim 1 wherein the controller is configured to report total usage related to each outgoing point code for calls terminating at the remote switching module.

12. The apparatus of claim 1 wherein the controller is configured to report total usage related to each destination point code for calls terminating at the remote switching module.

13. A method for monitoring PSTN/RSM call traffic comprising the steps of:
(A) a controller receiving out of band signaling from a host telecommunications switch which channels calls from the PSTN to an RSM;
(B) the controller trapping on out of band signaling related to a range of numbers related to lines terminated by a RSM; and
(C) the controller gathering call information related to those calls of interest, calls associated with lines terminated by the RSM.

14. The method of claim 13 further comprising the step of:
(D) the controller compiling call related data associated with the calls of interest.

15 The method of claim 14 further comprising the step of:
(E) the controller providing reports related to the calls of interest.

16. The method of claim 14 wherein the step D of compiling data associated with calls of interest includes the step of:
(D1) the controller monitoring calling number information within out of band signaling from the host telecommunications switch.

17. The method of claim 14 wherein the step D of compiling data associated with calls of interest includes the step of:
(D2) the controller monitoring originating point codes within the out of band signaling from the host telecommunications switch.

18. The method of claim 14 wherein the step D of compiling data associated with calls of interest includes the step of:
(D3) the controller monitoring destination point codes within the out of band signaling from the host telecommunications switch.

19. The method of claim 15 wherein the step E of reporting includes the step of:
(E1) the controller reporting incoming usage to the remote switching module from all other switches within the PSTN.

20. The method of claim 15 wherein the step E of reporting includes the step of:
(E2) the controller reporting outgoing usage from the remote switching module to all other switches within the PSTN.

21. The method of claim 15 wherein the step E of reporting includes the step of:
(E3) the controller reporting total usage related to each destination point code for calls terminating at the remote switching module.

22. A computer program product for use with an remote switch monitoring system comprising a computer usable medium having computer readable code thereon comprising:
code for receiving out of band signaling from a host telecommunications switch which channels calls from the PSTN to an RSM;
code for trapping on out of band signaling related to a range of numbers elated to lines terminated by a RSM; and
code for gathering call information related to those calls of interest, calls associated with lines terminated by the RSM.

22. The computer program product of claim 22 further comprising:
code for compiling call related data associated with the calls of interest.

23. The computer program product of claim 22 further comprising:
code for providing reports related to the calls of interest.
